(19) United States
(12) Patent Application Publication
(10) Pub. No.: US 2015/0004355 A1
(43) Pub. Date: Jan. 1, 2015

(54) VOID FILLER USABLE AS A HOLLOW DOOR CORE

(71) Applicant: Signode Industrial Group LLC, Glenview, IL (US)

(72) Inventors: Joseph Anthony Diaz, Stockton, CA (US); Randolph L. Gray, Stockton, CA (US); George C. Boyse, Rocklin, CA (US); Brian A. Swenson, Benton, AR (US)

(21) Appl. No.: 14/268,142

(22) Filed: May 2, 2014

Related U.S. Application Data
(60) Provisional application No. 61/840,964, filed on Jun. 28, 2013.

(51) Int. Cl. E06B 3/70

(52) U.S. Cl. CPC E06B 3/7015
USPC 428/118; 428/116

(57) ABSTRACT

Various embodiments of the present disclosure provide a void filler and a hollow door employing the void filler as a door core. Generally, the void filler expands from a compact collapsed state into an expanded state in which the void filler has an open-cell structure including three groups, such as columns, of six sided cells, such as generally hexagonal cells. The cells of the outer columns are substantially the same size, while the cells of the middle column are wider than the cells of the outer columns.

### PRIORITY CLAIM

This application claims priority to and the benefit of U.S. Provisional Patent Application No. 61/840,964, filed on Jun. 28, 2013, the entire contents of which are incorporated herein by reference.

### BACKGROUND

Open cell void fillers are well known. Typically, these known void fillers have collapsed and expanded states, and are formed from a plurality of plies of corrugated paperboard adhered to one another according, to a predetermined adherence pattern. When these known void fillers are manipulated from the collapsed state to the expanded state, the plies of the void filler bend along a plurality of bend lines proximate certain of the adherence points to create an open cell structure including a plurality of diamond-shaped or hexagonally-shaped cells.

Certain known void fillers are used as cores for hollow doors. Doors typically include front and back door skins separated by a door frame. The door frame includes two generally vertical stiles connected to generally horizontal top and bottom rails that form the edges of the door. The door skins and the door frame enclose and define a hollow area of the door between the door skins and within the door frame. The door includes at least one lock block or mounting block, which provides a mounting base for a door handle and locking assembly and extends into the hollow area. Certain known void fillers are employed as door cores to fill this hollow area and provide structural reinforcement to the door.

A variety of problems arise when using such known void fillers as door cores. Certain known void fillers expand irregularly and asymmetrically when being manipulated from the collapsed state to the expanded state. This often causes the void fillers to expand into and encroach upon the locations of the lock block(s) of the door. Additionally, the irregular and asymmetric expansion causes cell distortion and non-uniform coverage. That is, certain areas will include a relatively larger number of relatively smaller cells and other areas will include a relatively smaller number of relatively larger cells, though not by design. This causes the void finer to provide (unintended) extra support in certain areas of the door corresponding to the higher concentration of smaller cells (that may not need extra support) and less support in other areas of the door corresponding to the lower concentration of larger cells (that may need extra support).

Certain known void fillers employ cells of one size throughout the void filler without regard to which areas of the door need more or less structural support. This wastes material and money because not all areas of the door require the same amount of support.

Certain known void fillers include single-ply walls rather than double-ply walls, which increases the likelihood that the door skins, which are attached to the void filler, will de-laminate from the void filler and cause a “pillowing” effect that ruins the door.

Accordingly, there is a need for new and improved void filler that solves these problems.

### SUMMARY

Various embodiments of the present disclosure provide a void filler and a hollow door employing the void filler as a door core. Generally, the void filler expands from a compact collapsed state into an expanded state in which the void filler has an open-cell structure including three groups, such as columns, of six-sided cells, such as hexagonal cells. The cells of the outer columns are substantially the same size, while the cells of the middle column are wider than the cells of the outer columns.

More specifically, in one embodiment, the void filler includes a plurality of rectangular plies of corrugated paperboard arranged atop one another to form a stack. Adjacent plies of the stack are adhered to one another according to a predetermined adherence pattern. When the void filler is manipulated from the collapsed state to the expanded state, the plies bend along a plurality of bend lines proximate certain of the lines of adherence to create an open cell structure including a left group (such as a column) of six-sided cells, such as generally hexagonal cells; a middle group (such as a column) of six-sided cells, such as generally hexagonal cells; and a right group (such as a column) of six-sided cells, such as generally hexagonal cells. In this embodiment, the cells of the left column are generally the same size as one another, the cells of the middle column are generally the same size as one another, and the cells of the right column are generally the same size as one another. Further, in this embodiment, the cells of the left column are generally the same size as the cells of the right column, and the cells of the middle column are wider than the cells of the left column and the cells of the right column.

In another embodiment, the predetermined adherence pattern employed to form the void filler causes the void filler to have an hourglass shape when in the expanded state; that is, in this embodiment, the void filler is wider at its top and bottom than it is at its center when in the expanded state. Accordingly, the sizes of the cells in each respective column vary when the void filler is in the expanded state such that the cells: (a) increase in height and decrease in width proceeding from the top of the void filler downward toward the center of the void filler, (b) reach a maximum height and a minimum width near the center of the void filler, and (c) decrease in height and increase in width proceeding from the center of the void filler downward toward the bottom of the void filler.

In another embodiment, the void filler includes a plurality of plies attached to one another such that, when in an expanded state, the plies form: (a) a first group of cells; (b) a second group of cells, the cells of the second group of cells being substantially the same size as the cells of the first group of cells; and (c) a third group of cells between the first group of cells and the second group of cells, the cells of the third group of cells being wider than the cells of the first group of cells and the cells of the second group of cells.

In another embodiment, the void filler includes a plurality of plies attached to one another such that, when in an expanded state, the plies form: (a) a first group of six-sided cells, such as generally hexagonal cells; (b) a second group of six-sided cells, such as generally hexagonal cells, the cells of the second group of cells being substantially the same size as the cells of the first group of cells; and (c) a third group of six-sided cells, such as generally hexagonal cells, between the first group of cells and the second group of cells, the cells of the third group of cells being wider than the cells of the first group of cells and the cells of the second group of cells.

In another embodiment, the void filler includes a plurality of plies attached to one another such that, when in an expanded state, the plies form: (a) a first group of cells; (b) a second group of cells, the cells of the second group of cells being substantially the same size as the cells of the first group of cells; and (c) a third group of cells between the first group of cells and the second group of cells, the cells of the third group of cells being wider than the cells of the first group of cells and the cells of the second group of cells, wherein the cells proximate a first end of the void filler and the cells proximate a second end of the void filler are wider and shorter than the cells proximate a center of the void filler between the first end and the second end.

In one embodiment in which the void filler is employed as a door core for a hollow door, the door includes: (a) a door frame including a first rail (such as a top rail) and an opposing second rail (such as a bottom rail); and (b) a void filler attached to the door frame and including a plurality of plies, wherein: (i) a first ply is connected to the first rail; (ii) a second ply is connected to the second rail; and (iii) the plies are attached to one another such that the plies form: (A) a first group of cells; (B) a second group of cells, the cells of the second group of cells being substantially the same size as the cells of the first group of cells; and (C) a third group of cells between the first group of cells and the second group of cells, the cells of the third group of cells being wider than the cells of the first group of cells and the cells of the second group of cells.

In another embodiment in which the void filler is employed as a door core for a hollow door, the door includes: (a) a door frame including: (i) a first rail (such as a top rail), (ii) an opposing second rail (such as a bottom rail), (iii) a first stile connecting a first end of the first rail to a first end of the second rail, (iv) a second opposing stile connecting a second end of the first rail to a second end of the second rail, and (v) at least one lock block connected to one of the stiles; (b) a void filler including a plurality of plies, wherein: (i) a first ply is connected to the first rail; (ii) a second ply is connected to the second rail; and (iii) the plies are attached to one another such that the plies form: (A) a first column of six-sided cells, such as generally hexagonal cells; (B) a second column of six-sided cells, such as generally hexagonal cells, the cells of the second column of cells being substantially the same size as the cells of the first column of cells; and (C) a third column of six-sided cells, such as generally hexagonal cells, between the first column of cells and the second column of cells, the cells of the third column of cells being wider than the cells of the first column of cells and the cells of the second column of cells; (c) a first door skin attached to a first side of the door frame; and (d) a second door skin attached to an opposing second side of the door frame.

When used as a door core to fill the space enclosed by the components of a hollow door, the void filler of the present disclosure solves the above-described problems. More specifically, the void filler of the present disclosure is configured such that it expands evenly and symmetrically when being manipulated from the collapsed state to the expanded state and does not interfere with the lock block location(s) during construction of the door. The embodiment of the void filler having the hourglass shape when in the expanded state is also beneficial in that the hourglass shape substantially reduces or eliminates the potential for the void filler to encroach upon the lock blocks when the void filler is used as a core of a door.

Additionally, when in the expanded state, the void filler provides a rectangular, symmetrical, substantially uniform area of coverage and includes economically-sized cells. More particularly, the void filler includes relatively small cells positioned corresponding to areas of the door that require relatively more support and larger cells positioned corresponding to areas of the door that require relatively less support. The use of different cell sizes at specific positions corresponding to varying support requirements rather than using a single cell size throughout uses less material than known void fillers, thereby costing less and creating less waste than those known void filler while providing adequate support.

Further, the tops and bottoms of certain of the cells of the void filler are created by adhering adjacent plies to one another such that the tops and bottoms of these cells form “double-ply” corrugated paperboard. These double-ply top and bottom cell walls increase the bonding surface area between the void filler and the door skins, which strengthens the bonds and eliminates or substantially reduces the likelihood of “pillowing” caused by de-lamination of the void filler from the door skins that can occur due to poor bonding to single-ply corrugated paperboard.

Additional features and advantages of the present disclosure are described in, and will be apparent from, the following Detailed Description and the Figures.

### BRIEF DESCRIPTION OF THE DRAWINGS

FIG. 1A is a front elevational view of one embodiment of the void filler of the present disclosure in the expanded state.

FIG. 1B is an enlarged front elevational view of certain of the cells of the void filler of FIG. 1A in the expanded state.

FIG. 1C is an example size chart including example lengths of the sides of the cells of the void filler of FIG. 1A based on the size of the door with which the void filler is employed,

FIG. 1D is a top perspective view of the void filler of FIG. 1A in the expanded state.

FIG. 1E is a front elevational view of the void filler of FIG. 1A in the collapsed state.

FIG. 1F is a front elevational view of the void filler of FIG. 1A in the collapsed state illustrating the adherence pattern employed to form the void finer.

FIG. 2A is a front elevational view of the void filler of FIG. 1A in the collapsed state and attached to a top rail and a bottom rail of a door frame of a hollow door.

FIG. 2B is a front elevational view of the void filler of FIG. 2A being manipulated from the collapsed state to the expanded state.

FIG. 2C is a front elevational view of the void filler of FIG. 2A in the expanded state, wherein the door frame includes two stiles and two lock blocks.

FIG. 2D is a front elevational and partial fragmentary view of the door showing the void filler of FIG. 2A within.

FIG. 3A is a front elevational view of one embodiment of the void filler of the present disclosure in the expanded state.

FIG. 3B is a top perspective view of the void filler of FIG. 3A in the expanded state.

FIG. 3C is a front elevational view of the void filler of FIG. 3A in the collapsed state.

FIG. 3D is a front elevational view of the void filler of FIG. 3A in the collapsed state illustrating the adherence pattern employed to form the void filler.

FIG. 4A is a front elevational view of the void filler of FIG. 3A in the collapsed state and attached to a top rail and a bottom rail of a door frame of a hollow door.

FIG. 4B is a front elevational view of the void filler of FIG. 4A being manipulated from the collapsed state to the expanded state.

FIG. 4C is a front elevational view of the void filler of FIG. 4A in the expanded state, wherein the door frame includes two stiles and two lock blocks.

FIG. 4D is a front elevational and partial fragmentary view of the door showing the void filler of FIG. 4A within,

FIG. 5A is a front elevational view of another embodiment of the void filler of the present disclosure in the collapsed state,

FIG. 5B is a front elevational view of the void filler of FIG. 5A in the collapsed state illustrating the adherence pattern employed to form the void filler.

FIG. 5C is a front elevational view of the void filler of FIG. 5A in the collapsed state and attached to a top rail and a bottom rail of a door frame of a hollow door.

FIG. 5D is a front elevational view of the void filler of FIG. 5C being manipulated from the collapsed state to the expanded state.

FIG. 5E is a front elevational view of the void filler of FIG. 5D in the expanded state, wherein the door frame includes two stiles and two lock blocks.

FIG. 6A is a front elevational view of another embodiment of the void filler of the present disclosure in the collapsed state.

FIG. 6B is a front elevational view of the void filler of FIG. 6A in the collapsed state illustrating the adherence pattern employed to form the void filler.

FIG. 6C is a front elevational view of the void filler of FIG. 6A in the collapsed state and attached to a top rail and a bottom rail of a door frame of a hollow door.

FIG. 6D is a front elevational view of the void filler of FIG. 6C being manipulated from the collapsed state to the expanded state.

FIG. 6E is a front elevational view of the void filler of FIG. 6D in the expanded state, wherein the door frame includes two stiles and two lock blocks.

### DETAILED DESCRIPTION

Various embodiments of the present disclosure provide a void filler and a hollow door employing the void filler as a door core. Generally, the void filler expands from a compact collapsed state into an expanded state in which the void filler has an open-cell structure including three groups, such as columns, of six-sided cells, such as generally hexagonal cells. The cells of the outer columns are substantially the same size, while the cells of the middle column are wider than the cells of the outer columns.

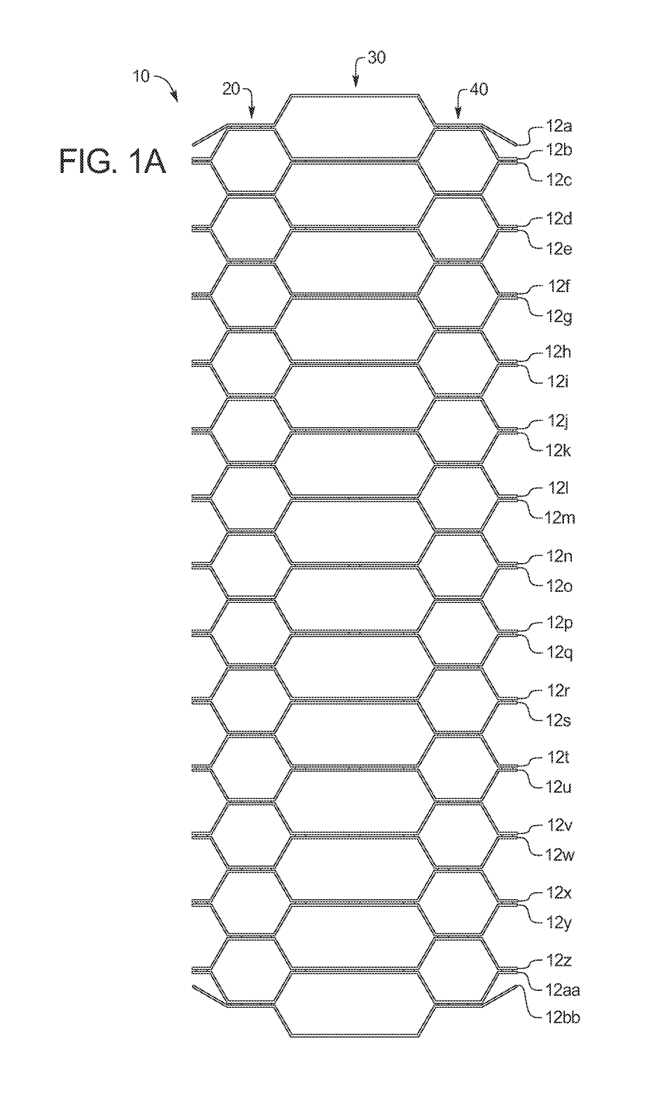

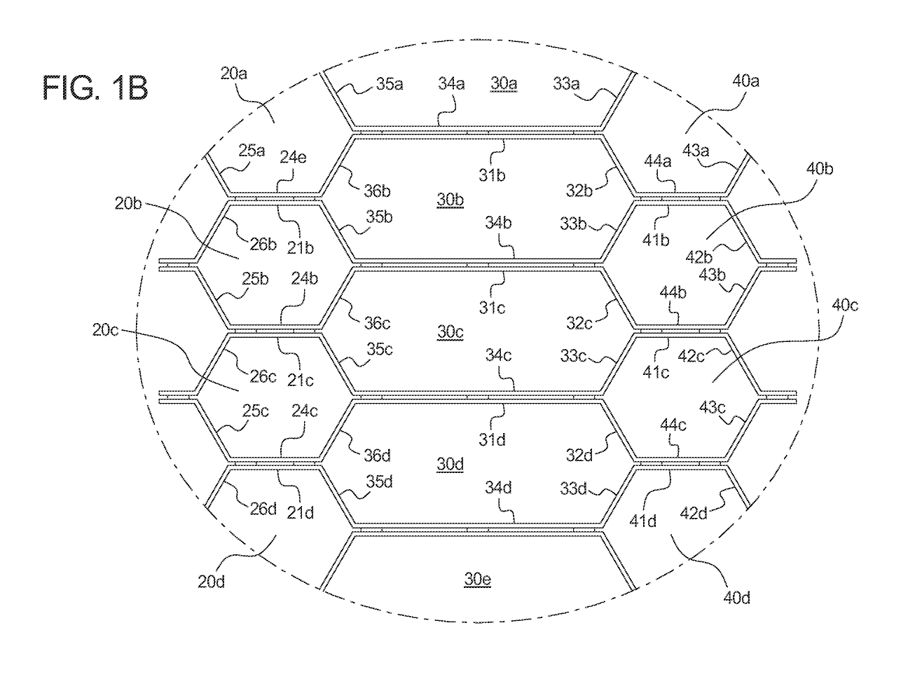

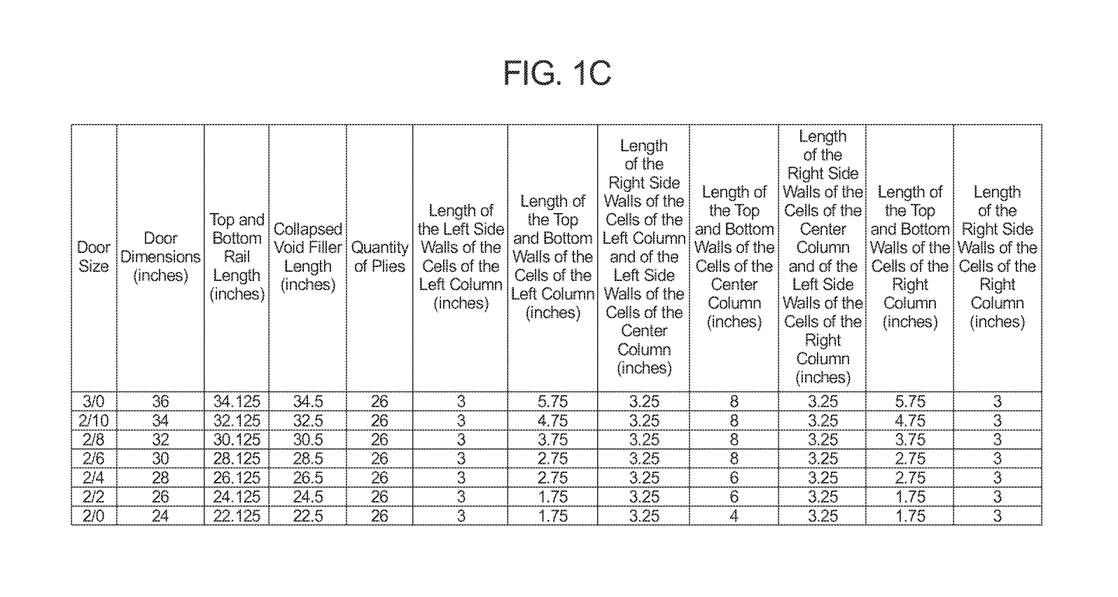

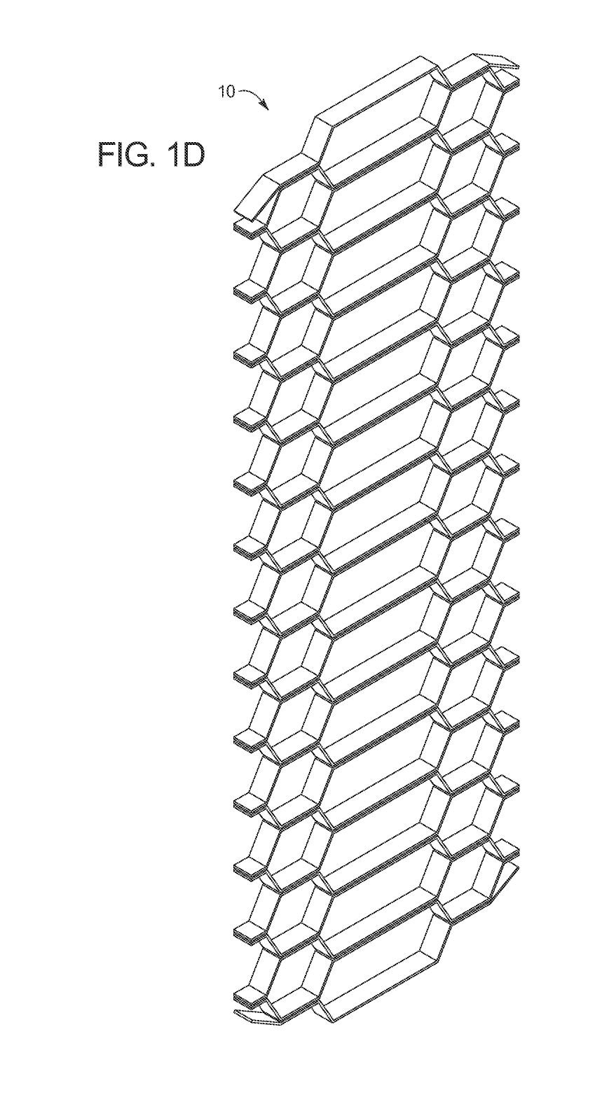

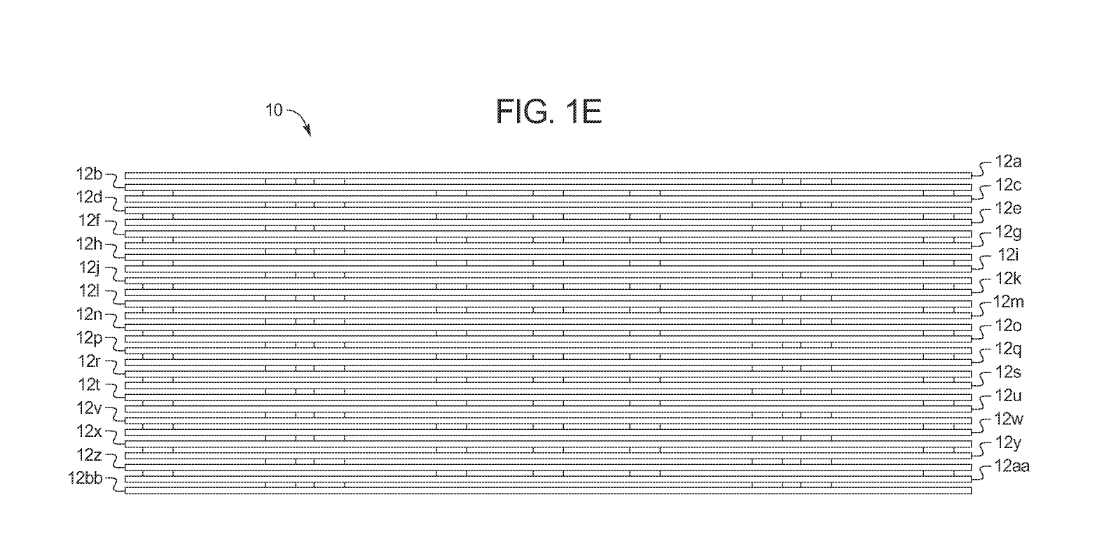

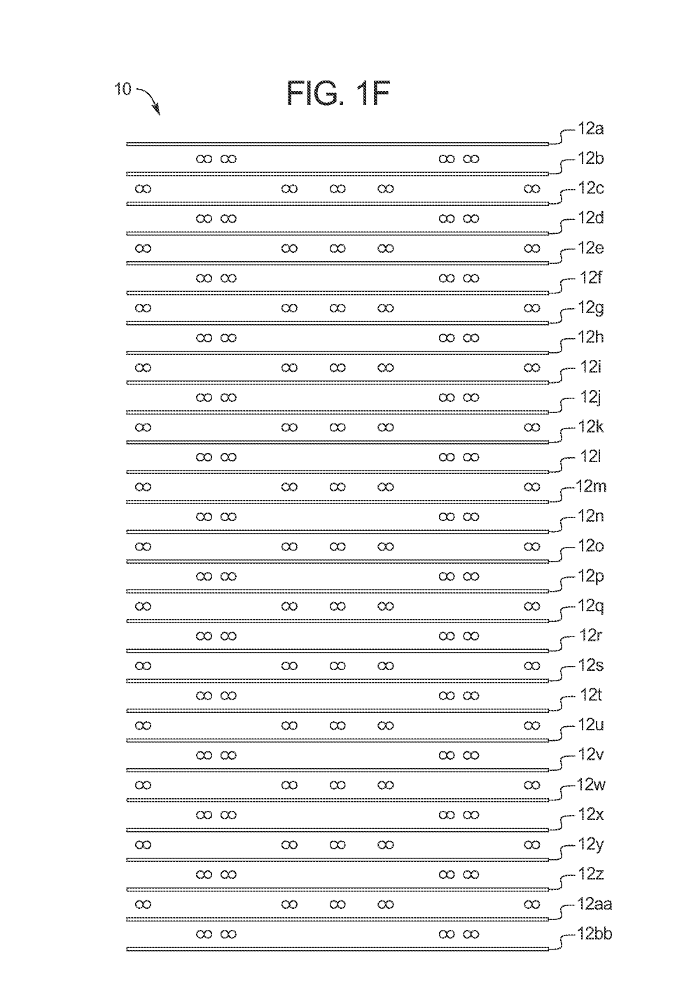

Referring now to the drawings, FIGS. 1A, 1B, 1D, 1E, and 1F illustrate one embodiment of the void filler of the present disclosure, which is generally indicated by numeral 10. More specifically, FIGS. 1A, 1B, and 1D illustrate the void filler 10 in an expanded state, FIG. 1E illustrates the void filler 10 in a collapsed state, and FIG. 1F illustrates the adherence pattern employed to form this embodiment of the void filler 10 (explained below).

In this embodiment, the void filler 10 includes a plurality of rectangular plies 12a to 12bb of corrugated paperboard arranged atop one another to forma stack. It should be appreciated that the plies may be made of any other suitable material. Adjacent plies 12 of the stack are adhered to one another according to the predetermined adherence pattern illustrated in FIG. 1F. In FIG. 1F, each circle represents a center of a line of adherence along which adjacent plies 12 are adhered to one another. It should be appreciated that the adherence pattern employed to adhere adjacent plies to one another dictates: (a) how the cells of the void filler (described below) are formed when the void filler is expanded from the collapsed state into the expanded state, (b) the size of the cells, and (c) the shape of cells. It should be appreciated that the plies may be adhered to one another in any suitable manner, such as (but not limited to) via an adhesive (e.g., a starch-based glue or any other suitable type of glue), tape, and/or staples.

When the void filler 10 is manipulated from the collapsed state to the expanded state, the plies 12 of the void filler 10 bend along a plurality of bend lines proximate certain of the lines of adherence to create an open cell structure including: a left group 20 of six-sided cells, such as generally hexagonal cells; a middle group 30 of six-sided cells, such as generally hexagonal cells; and a right group 40 of six-sided cells, such as generally hexagonal cells. In this embodiment, the groups are columns of cells due to the orientation of the void filler, though it should be appreciated that the groups may be rows or other configurations depending on the orientation of the void filler. In certain embodiments, the plies are scored, perforated, or creased along at least part of one or more of the bend lines to facilitate bending of the plies when the void filler is manipulated from the collapsed state to the expanded state. It should be appreciated that, in other embodiments, the cells may take different shapes, such as diamond shapes, and have any suitable quantity of sides, such as four sides or five sides.

As shown in FIG. 1B, each generally hexagonal cell includes a top wall, a upper right side wall, a lower right side wall, a bottom wall, a lower left side wall, and an upper left side wall. For instance: (a) cell 30b of the middle column 30 includes: a top wall 31b (which is adhered to a bottom wall 34a of cell 30a), an upper right side wall 32b (which is also the lower left side wall of cell 40a), a lower right side wall 33b (which is also an upper left side wall of cell 40b), a bottom wall 34b (which is adhered to atop wall 31c of cell 30c), a lower left side wall 35b (which is also an upper right side wall of cell 20b), and an upper left side wall 36b (which is also a lower right side wall of cell 20a); (b) cell 20b of the left column 20 includes: atop wall 21b (which is adhered to a bottom wall 24a of cell 20a), an upper right side wall 35b (which is also the lower left side wall of cell 30b), a lower right side wall 36c (which is also the upper left side wall of cell 30c), a bottom wall 24b (which is adhered to a top wall 21c of cell 20c), a lower left side wall 25b, and an upper left side wall 26b; and (c) cell 40b of the right column 40 includes: a top wall 41b (which is adhered to a bottom wall 44a of cell 40a), an upper right side wall 42b, a lower right side wall 43b, a bottom wall 44b (which is adhered to a top wall 41c of cell 40c), a lower left side wall 32c (which is also the upper right side wall of cell 30c), and an upper left side wall 33b (which is also the lower right side wall of cell 30b).

In this embodiment, the cells of the left column 20 are generally the same size as one another, the cells of the middle column 30 are generally the same size as one another, and the cells of the right column 40 are generally the same size as one another. More specifically, in this embodiment, for a given column of cells, the top walls of each cell in the column are generally the same size, the upper right side walls of each cell in the column are generally the same size, the lower right side walls of each cell in the column are generally the same size, the bottom walls of each cell in the column are generally the same size, the lower left side walls of each cell in the column are generally the same size, and the upper left side walls of each cell in the column are generally the same size. Further, in this embodiment, the cells of the left column 20 are generally the same size as the cells of the right column 40.

Additionally, in this embodiment, the cells of the middle column 30 are differently sized than the cells of the left column 20 and the cells of the right column 40. More specifically, in this embodiment: (a) the top walls of the cells of the middle column 30 are longer than the top walls of the cells of the left column 20 and the top walls of the cells of the right column 40, and (b) the bottom walls of the cells of the middle column 30 are longer than the bottom walls of the cells of the left column 20 and the bottom walls of the cells of the right column 40. Here, the top and bottom walls of the cells of the middle column 30 are about twice as long as the top and bottom walls of the cells of the left column 20 and the top and bottom walls of the cells of the right column 40,

FIG. 1C illustrates an example size chart including example lengths of the sides of the cells of this example void filler based on the size of the door with which the void filler is employed. It should be appreciated that the sides of the cells may have any suitable lengths.

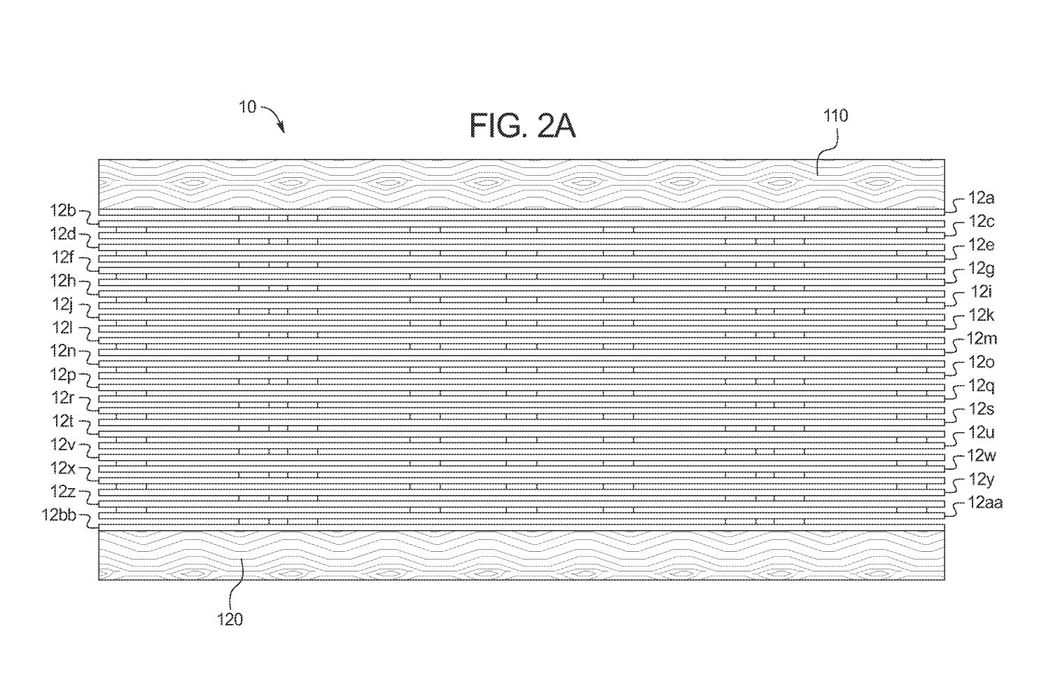

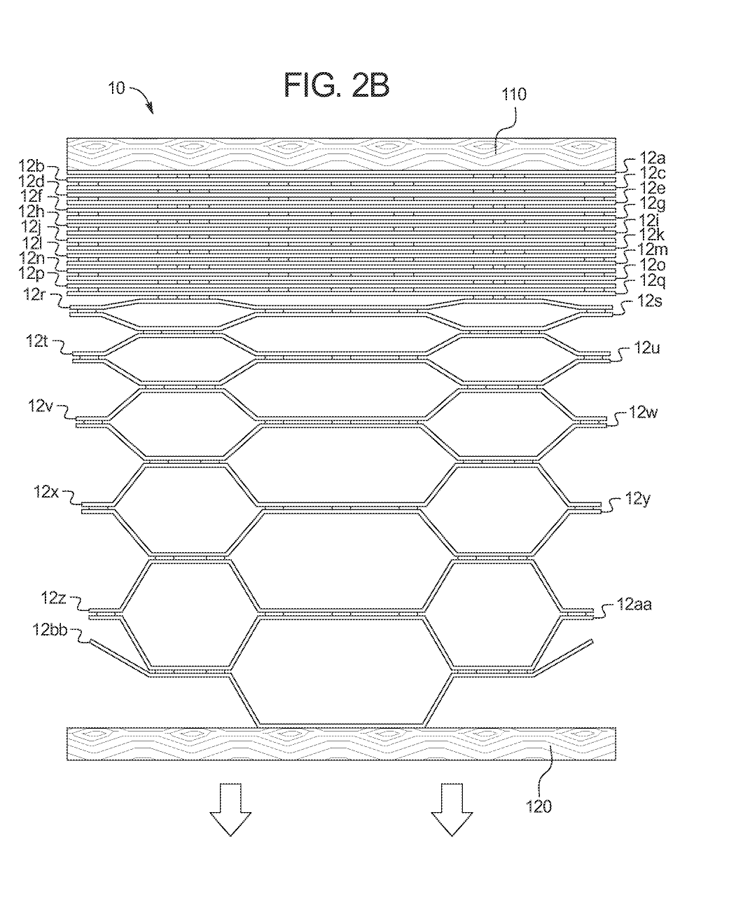

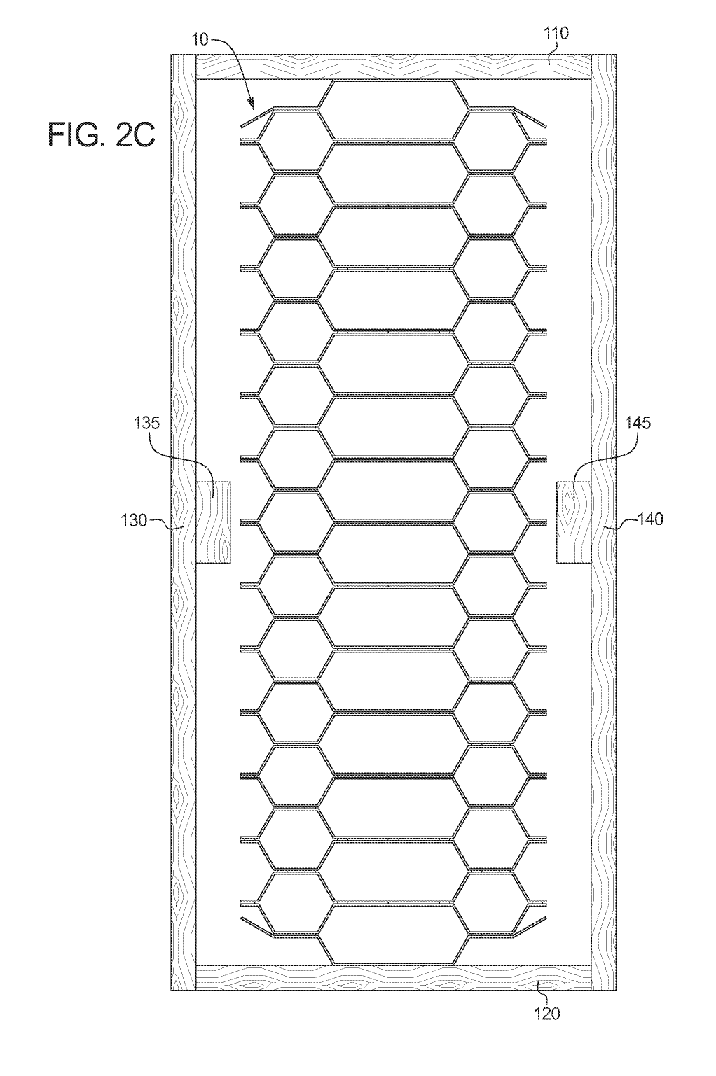

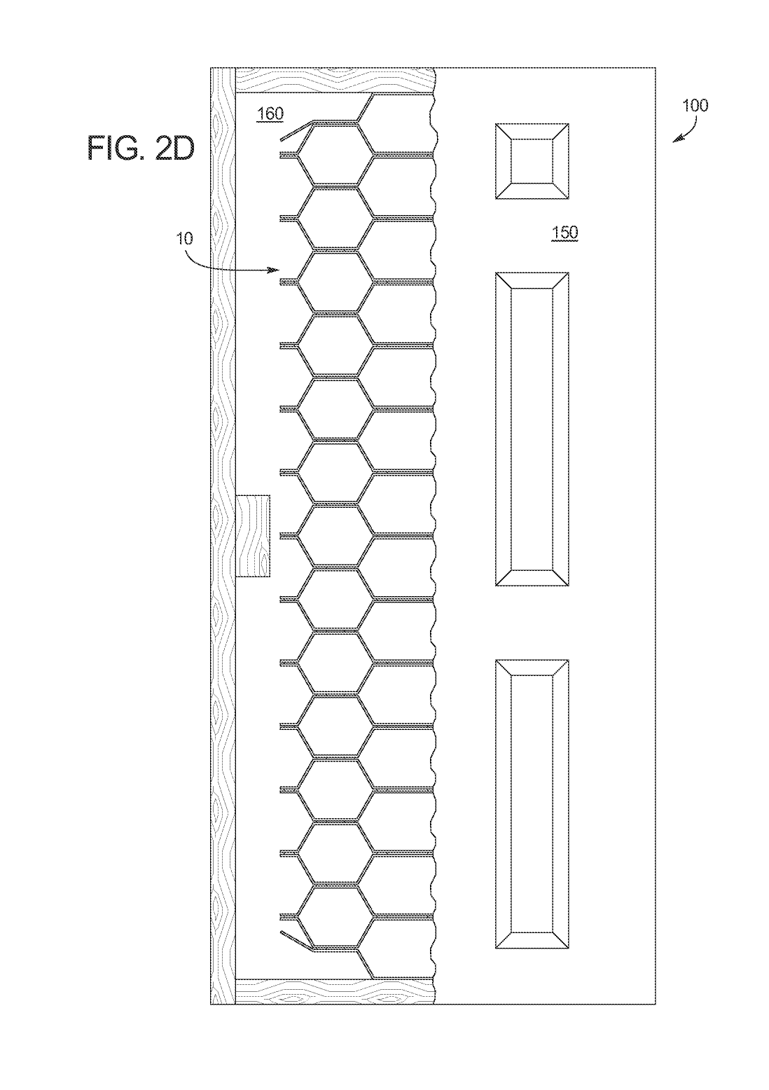

FIGS. 2A to 2D illustrate the void filler 10 employed as a core of a hollow door 100. To form the door 100, as shown in FIG. 2A, a top rail 110 is connected to the top ply 12a of the void filler 10 (when in the collapsed state) and a bottom rail 120 is connected to the bottom ply 12bb of the void filler 10. More specifically, in this example embodiment, the bottom surface of the top rail 110 is adhered to a designated attachment portion of the top surface of the top ply 12a of the void filler 10 via an adhesive (such as glue), and the top surface of the bottom rail 120 is adhered to a designated attachment portion of the bottom surface of the bottom ply 12bb of the void filler 10 via an adhesive (such as glue). For instance, the bottom surface of the top rail includes a centered glue line such that when the top surface of the top ply is pressed onto the bottom surface of the top rail, the designated attachment portion of the top surface of the top ply is adhered to the top rail via the glue. It should be appreciated that the top and bottom plies of the void filler may be connected to the top and bottom rails, respectively, in any suitable manner.

As best shown in FIG. 2B, the width of the designated attachment portion of the bottom surface of the bottom ply 12bb attached to the top surface of the bottom rail 120 is substantially equal to the width of the top wall of the bottommost cell of the void filler 10 (with respect to the orientation shown in FIG. 2B). This causes the bottom wall of the bottommost cell of the void filler 10 to be substantially the same width as the top wall of the bottommost cell of the void filler 10. Similarly, as best shown in FIG. 2C, the width of the designated attachment portion of the top surface of the top ply 12a attached to the bottom surface of the top rail 110 is substantially equal to the width of the bottom wall of the topmost cell of the void filler 10 (with respect to the orientation shown in FIG. 2C. This causes the top wall of the topmost cell of the void filler 10 to be substantially the same width as the bottom wall of the topmost cell of the void filler 10. It should thus be appreciated that, in this embodiment, the sizes (and, more particularly, the widths) of the designated attachment portions of the top and bottom plies at least in part determine the shapes of the topmost and bottommost cells of the void filler, respectively.

As illustrated in FIG. 2B, the void filler 10 is expanded from the collapsed state to the expanded state by: (a) holding the top rail 110 stationary and pulling the bottom rail 120 downward, (b) holding the bottom rail 120 stationary and pulling the top rail 110 upward, or (c) a combination of (a) and (b), it should be appreciated that the void filler 10 expands evenly and symmetrically when being manipulated from the collapsed state to the expanded state and does not interfere with the lock block location(s) (explained below).

As shown in FIGS. 2C and 2D, after the void filler 10 is in the expanded state, a left stile 130 is connected to the left ends of the top rail 110 and the bottom rail 120 and a right stile 140 is connected to the rights ends of the top rail 110 and the bottom rail 120 to form a frame of the door 100. A left lock block or mounting block 135 and a right lock block or mounting block 145, which provide mounting bases for a door handle and locking assembly (not shown), are attached to the left stile 130 and the right stile 140, respectively. Front and back door skins 150 and 160 are attached to the front and back, respectively, of the door frame and the void filler 10 to complete assembly of the door 100.

When in the expanded state, the void filler provides a rectangular, symmetrical, substantially uniform area of coverage and includes economically-sized cells. More particularly, the void filler includes relatively small cells positioned corresponding to areas of the hollow door that require relatively more support and larger cells positioned corresponding to areas of the hollow door that require relatively less support. The use of different cell sizes at specific positions corresponding to varying support requirements rather than using a single cell size throughout uses less material than known void fillers, thereby costing less and creating less waste than those known void fillers while providing adequate support.

Further, as best shown in FIGS. 1A, 1B, 1D, 2C, and 2D, the tops and bottoms of certain of the cells of the void filler are created by adhering adjacent plies to one another such that the (connected) tops and bottoms of these cells form “double-ply” corrugated paperboard. These double-ply top and bottom cell walls increase the bonding surface area between the void filler and the door skins, which strengthens the bonds and eliminates or substantially reduces the likelihood of “pillowing” caused by de-lamination of the void filler from the door skins that can occur due to poor bonding to single-ply corrugated paperboard.

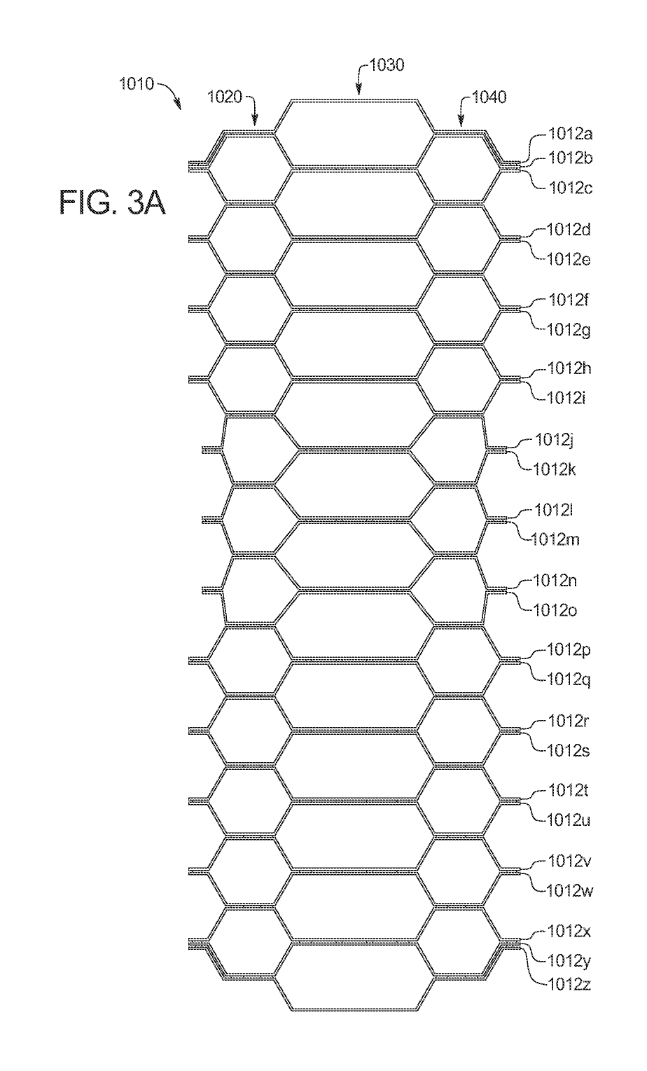

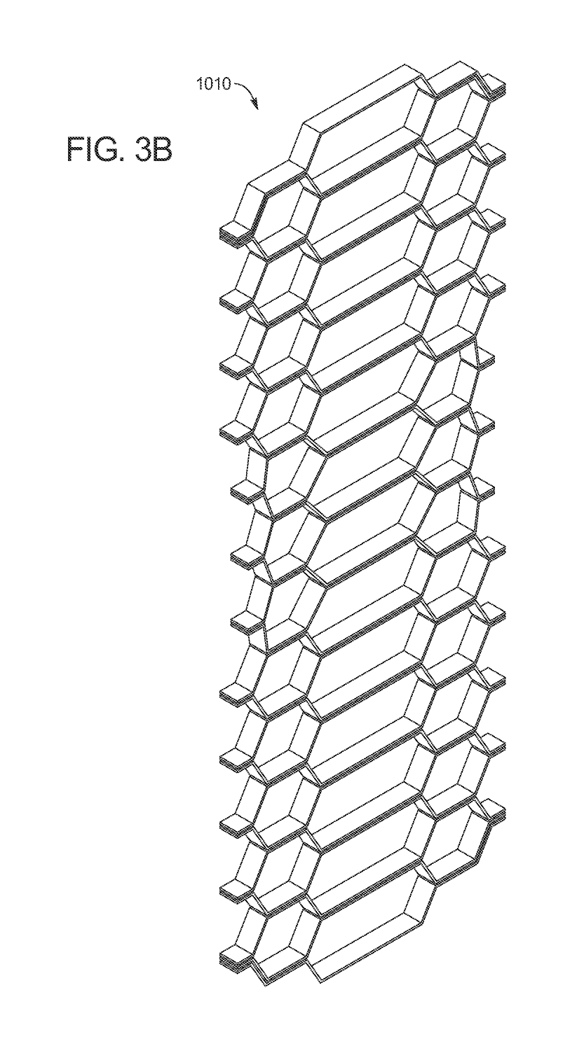

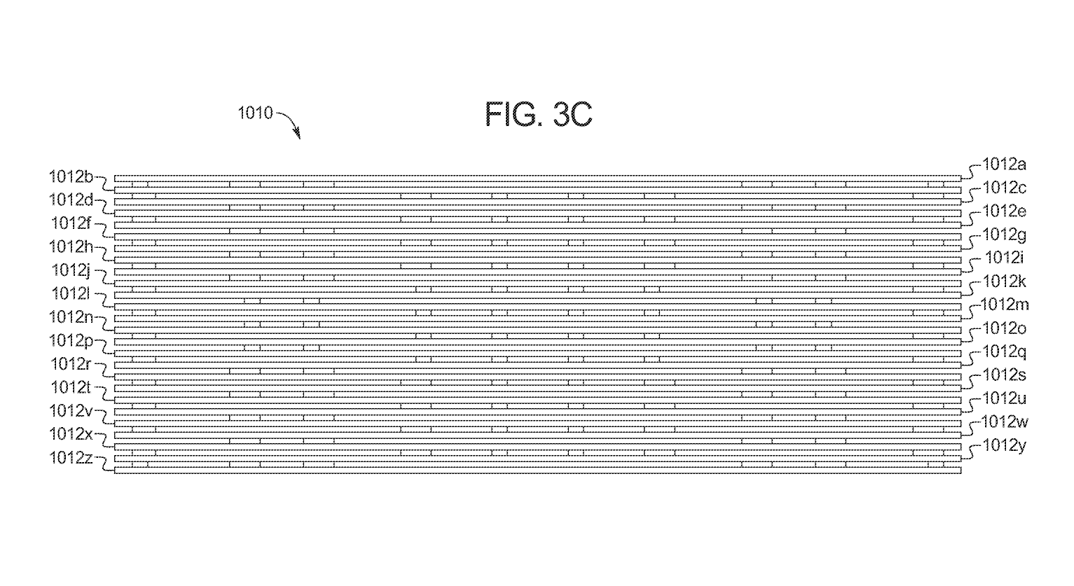

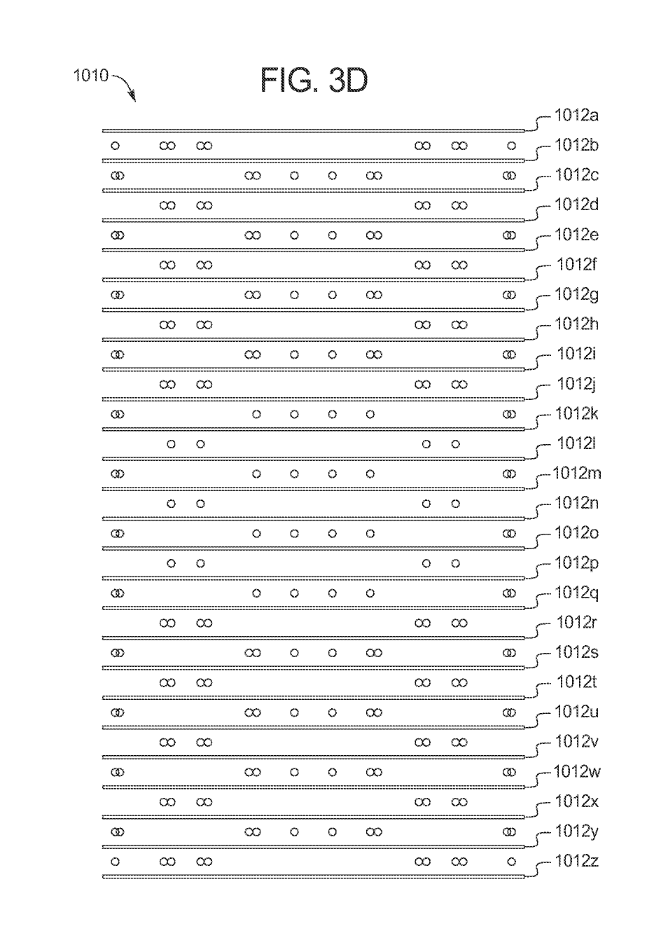

FIGS. 3A to 3D illustrate another embodiment of the void filler of the present disclosure, which is generally indicated by numeral 1010. More specifically, FIGS. 3A and 3B illustrate the void filler 1010 in the expanded state, FIG. 3C illustrates the void filler 1010 in the collapsed state, and FIG. 3D illustrates the adherence pattern employed to form this embodiment of the void filler 1010.

In this embodiment, the void filler 1010 includes a plurality of rectangular plies 1012a to 1012bb of corrugated paperboard arranged atop one another to form a stack. Adjacent plies 1012 of the stack are adhered to one another according to the predetermined adherence pattern illustrated in FIG. 3D, which is different than the adherence pattern illustrated in FIG. 1F. In FIG. 3D, each circle represents a center of a line of adherence along which adjacent plies 1012 are adhered to one another.

When the void filler 1010 is manipulated from the collapsed state to the expanded state, the plies 1012 of the void filler 1010 bend along a plurality of bend lines proximate certain of the lines of adherence to create an open cell structure including: a left group 1020 of six-sided cells, such as generally hexagonal cells; a middle group 1030 of six-sided cells, such as generally hexagonal cells; and a right group 1040 of six-sided cells, such as generally hexagonal cells. In this embodiment, the groups are columns of cells due to the orientation of the void filler, though it should be appreciated that the groups may be rows or other configurations depending on the orientation of the void filler is oriented differently. In certain embodiments, the plies are scored, perforated, or creased along at least part of one or more of the bend lines to facilitate bending of the plies when the void filler is manipulated from the collapsed state to the expanded state.

In this embodiment, the cells of the left column 1020 are generally the same size as the corresponding cells of the right column 1040 (as generally described above), and the cells of the middle column 1030 are differently sized than the cells of the left column 1020 and the cells of the right column 1040 (as generally described above). More specifically, in this embodiment, the cells of the middle column 1030 are wider than the cells of the left column 1020 and the cells of the right column 1040 (as generally described above). Here, the cells of the middle column 1030 are about twice as wide as the cells of the left column 1020 and the cells of the right column 1040.

In this embodiment, the size of the cells in each respective column varies. More specifically, for each column of cells 1020, 1030, and 1040, the adherence pattern employed for this embodiment of the void filler 1010 causes the cells to: (a) increase in height (via, an increase in length of the upper right side, lower right side, lower left side, and upper left side walls) and decrease in width (via a decrease in length of the top and bottom walls) proceeding from the top of the void filler 1010 downward toward a center of the void filler 1010, (b) reach a maximum height a maximum length of the upper right side, lower right side, lower left side, and upper left side walls) and a minimum width (i.e., a minimum length of the top and bottom walls) near the vertical center of the void filler 1010, and (c) decrease in height (via a decrease in length of the upper right side, lower right side, lower left side, and upper left side walls) and increase in width (via an increase in length of the top and bottom walls) proceeding from the center of the void filler 1010 downward toward the bottom of the void filler 1010. This causes the void filler 1010 to have an hourglass shape in the expanded state; that is, in this embodiment, the void filler 1010 is wider at its top and bottom than it is at its center when in the expanded state.

This hourglass shape is beneficial in that it substantially reduces or eliminates the potential for the void filler to encroach upon the lock blocks when the void filler is used as a core of a door, as explained below.

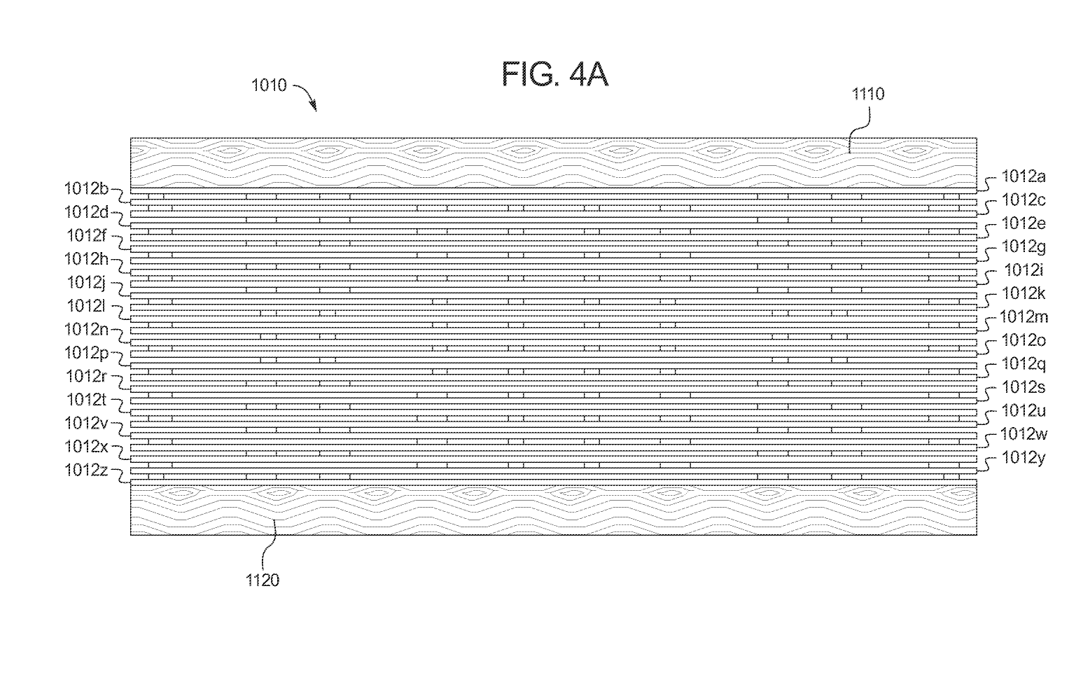

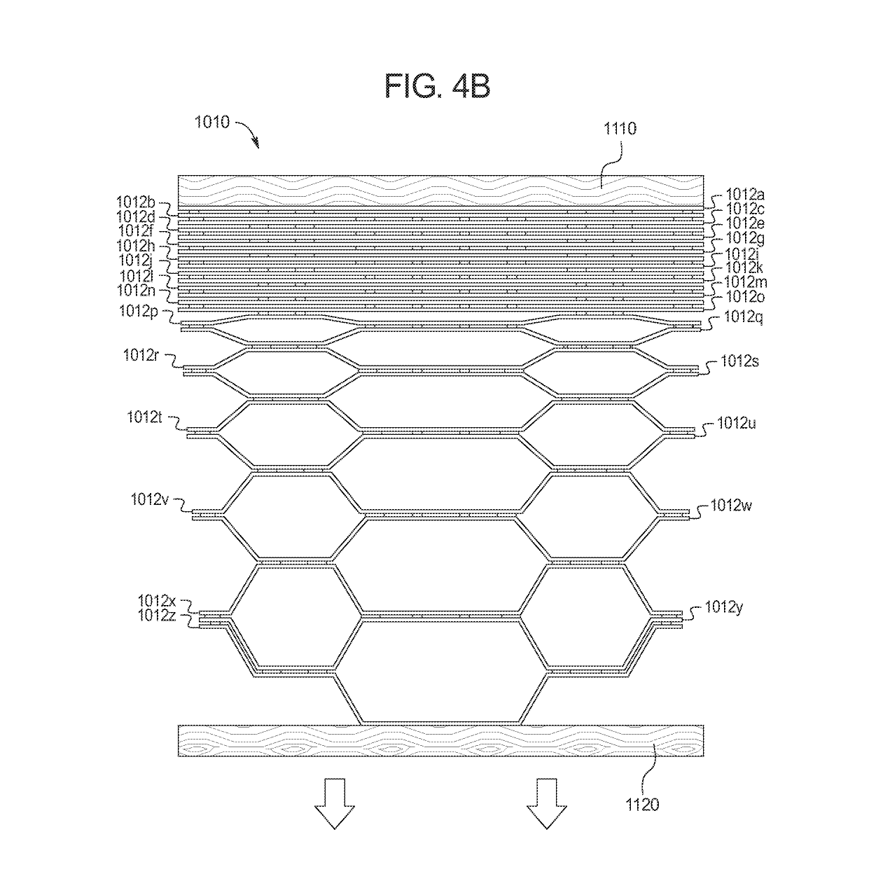

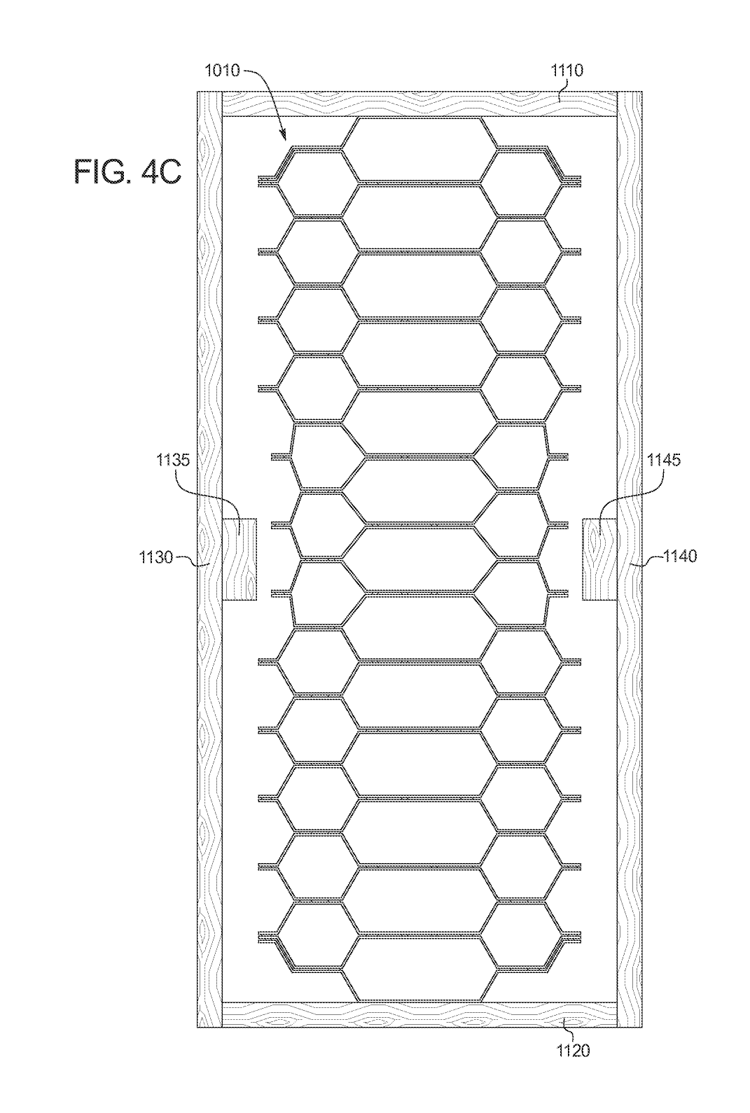

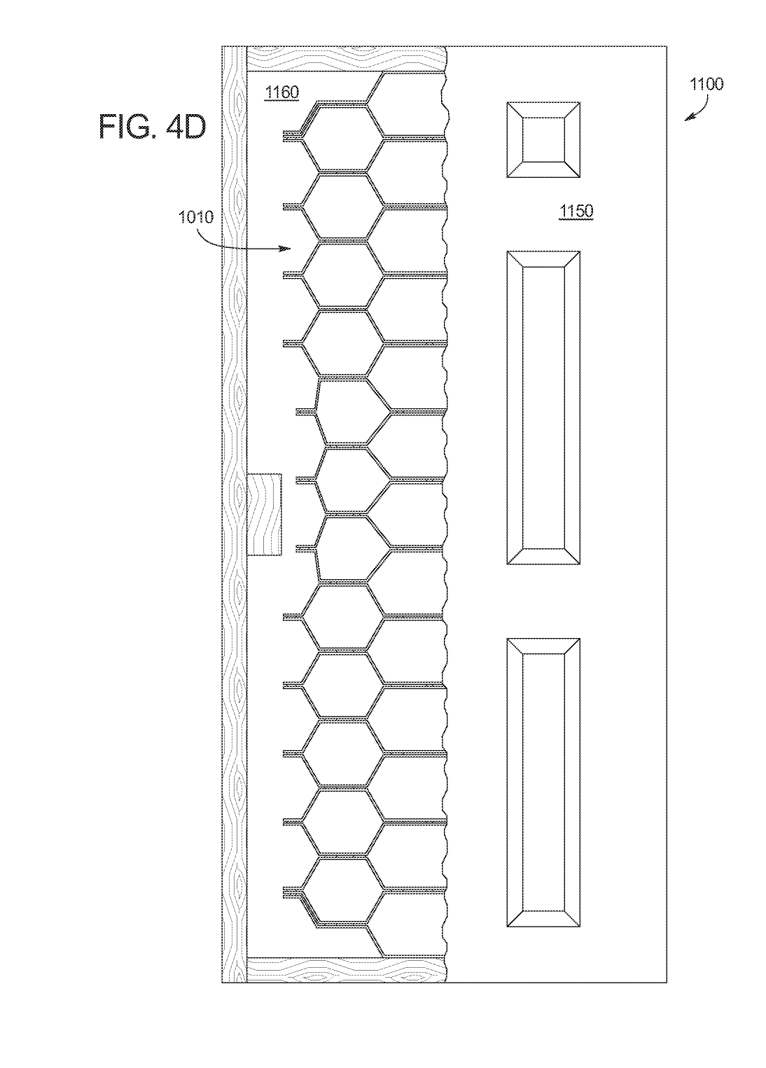

FIGS. 4A to 4D) illustrate the void filler 1010 employed as a core of a hollow door 1100. To form the door 1100, as shown in FIG. 4A, a top rail 1110 is connected to the top ply 1012a of the void filler 1010 (when in the collapsed state) and a bottom rail 1120 is connected to the bottom ply 1012bb of the void filler 1010. More specifically, in this example embodiment, the bottom surface of the top rail 1110 is adhered to a designated attachment portion of the top surface of the top ply 1012a of the void filler 1010 via an adhesive (such as glue), and the top surface of the bottom rail 1120 is adhered to a designated attachment portion of the bottom surface of the bottom ply 1012bb of the void filler 1010 via an adhesive (such as glue). It should be appreciated that the top and bottom plies of the void filler may be connected to the top and bottom rails, respectively, in any suitable manner.

As best shown in FIG. 4B, the width of the designated attachment portion of the bottom surface of the bottom ply 1012bb attached to the top surface of the bottom rail 1120 is substantially equal to the width of the top wall of the bottommost cell of the void filler 1010 (with) respect to the orientation shown in FIG. 4B). This causes the bottom wall of the bottommost cell of the void filler 1010 to be substantially the same width as the top wall of the bottommost cell of the void filler 1010. Similarly, as best shown in FIG. 4C, the width of the designated attachment portion of the top surface of the top ply 1012a attached to the bottom surface of the top rail 1110 is substantially equal to the width of the bottom wall of the topmost cell of the void filler 1010 (with respect to the orientation shown in FIG. 4C. This causes the top wall of the topmost cell of the void filler 1010 to be substantially the same width as the bottom wall of the topmost cell of the void filler 1010. It should thus be appreciated that, in this embodiment, the sizes (and, more particularly, the widths) of the designated attachment portions of the top and bottom plies at least in part determine the shapes of the topmost and bottommost cells of the void filler, respectively.

As illustrated in FIG. 4B, the void filler 1010 is expanded from the collapsed state to the expanded state by: (a) holding the top rail 1110 stationary and pulling the bottom rail 1120 downward, (b) holding the bottom rail 1120 stationary and pulling the top rail 1110 upward, or (c) a combination of (a) and (b). It should be appreciated that the void filler 10 expands evenly and symmetrically when being manipulated from the collapsed state to the expanded state and does not interfere with the lock block location(s) (explained below).

As shown in FIGS. 4C and 4D, after the void filler 1010 is in the expanded state, a left stile 1130 is connected to the left ends of the top rail 1110 and the bottom rail 1120 and a right stile 1140 is connected to the rights ends of the top rail 1110 and the bottom rail 1120 to form a frame of the door 1100. A left lock block or mounting block 1135 and a right lock block or mounting block 1145, which provide mounting bases for a door handle and locking assembly (not shown), are attached to the left stile 1130 and the right stile 1140, respectively. Front and back door skins 1150 and 1160 are attached to the front and back, respectively, of the door frame and the void filler 1010 to complete assembly of the door 1100.

When in the expanded state, the void filler provides a rectangular, symmetrical, substantially uniform area of coverage and includes economically-sized cells. More particularly, the void filler includes relatively small cells positioned corresponding to areas of the hollow door that require relatively more support and larger cells positioned corresponding to areas of the hollow door that require relatively less support. The use of different cell sizes at specific positions corresponding to varying support requirements rather than using a single cell size throughout uses less material than known void fillers, thereby costing less and creating less waste than those known void fillers while providing adequate support.

Further, as best shown in FIGS. 3A, 3B, 4C, and 4D, the tops and bottoms of certain of the cells of the void filler are created by adhering adjacent plies to one another such that the tops and bottoms of these cells are formed by “double-ply” corrugated paperboard. These double-ply top and bottom cell walls increase the bonding surface area between the void filler and the door skins, which strengthens the bonds and eliminates or substantially reduces the likelihood of “pillowing” caused by de-lamination of the void filler from the door skins that can occur due to poor bonding to single-ply corrugated paperboard.

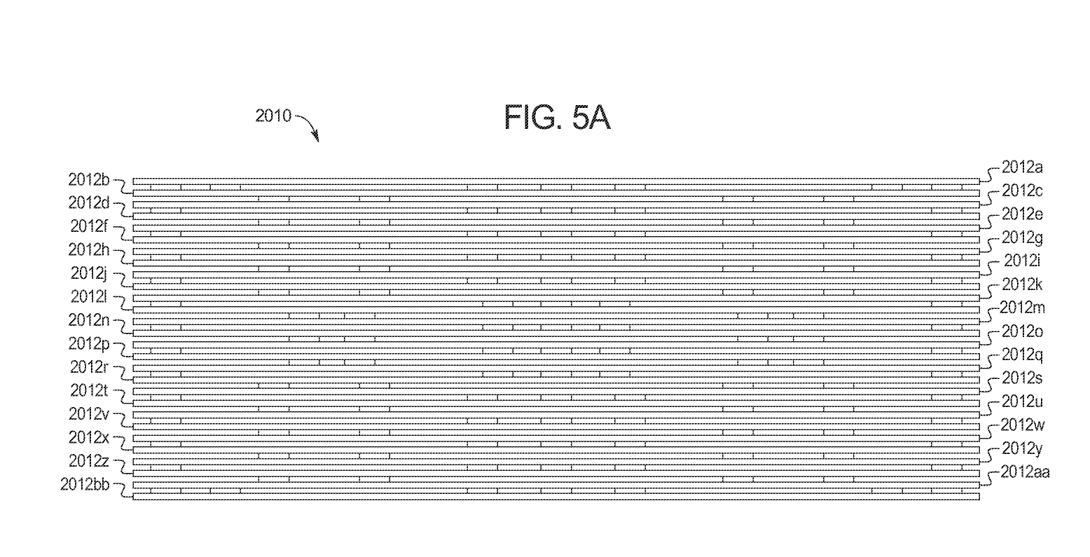

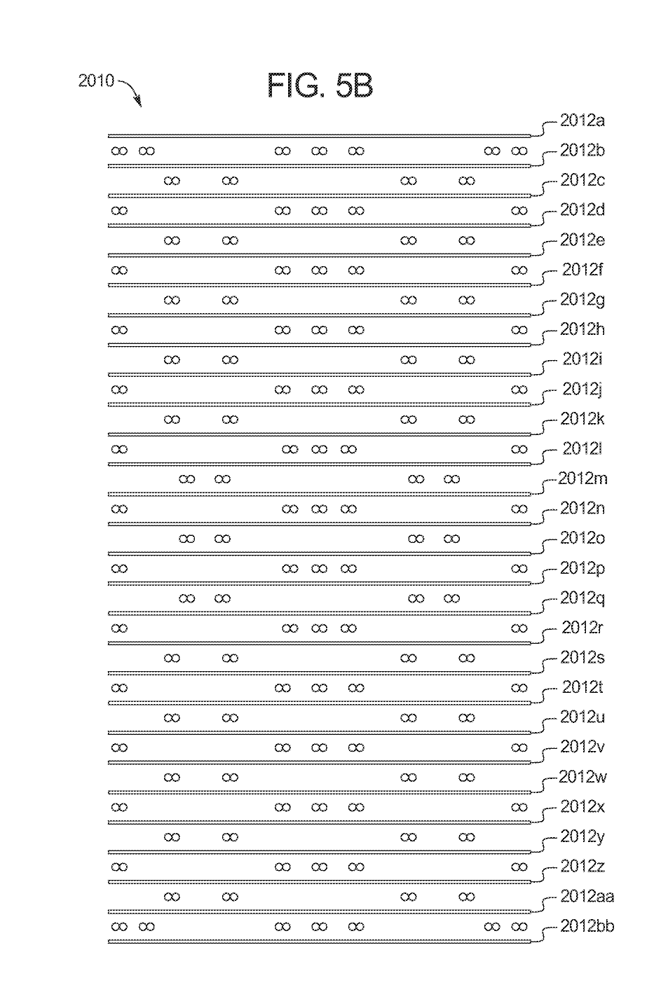

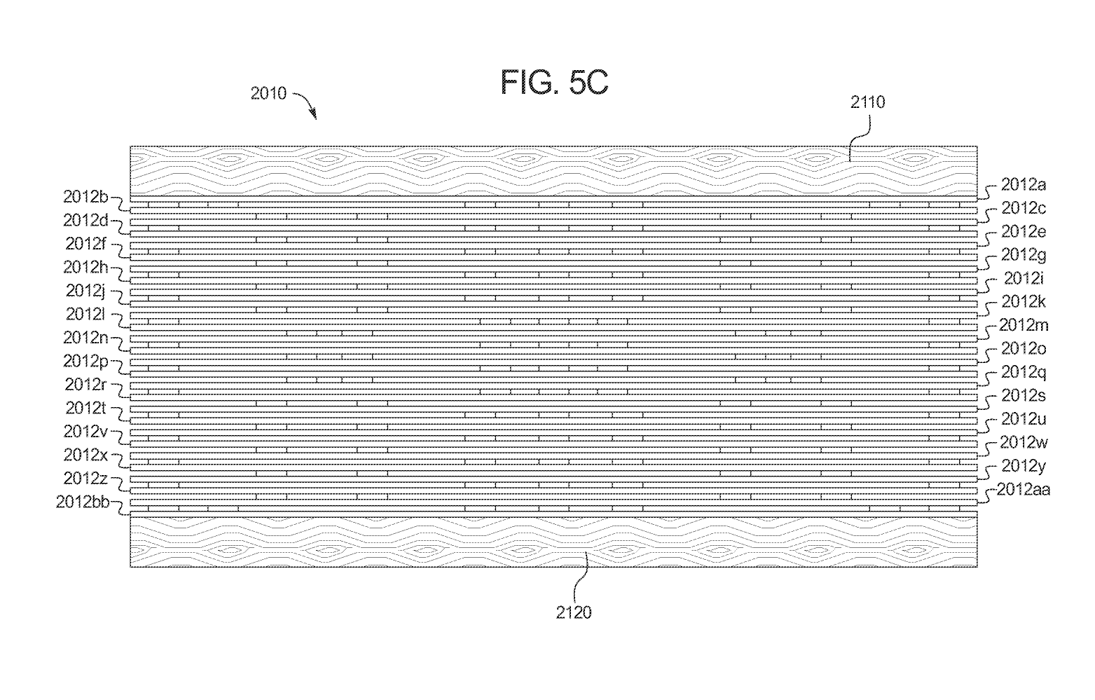

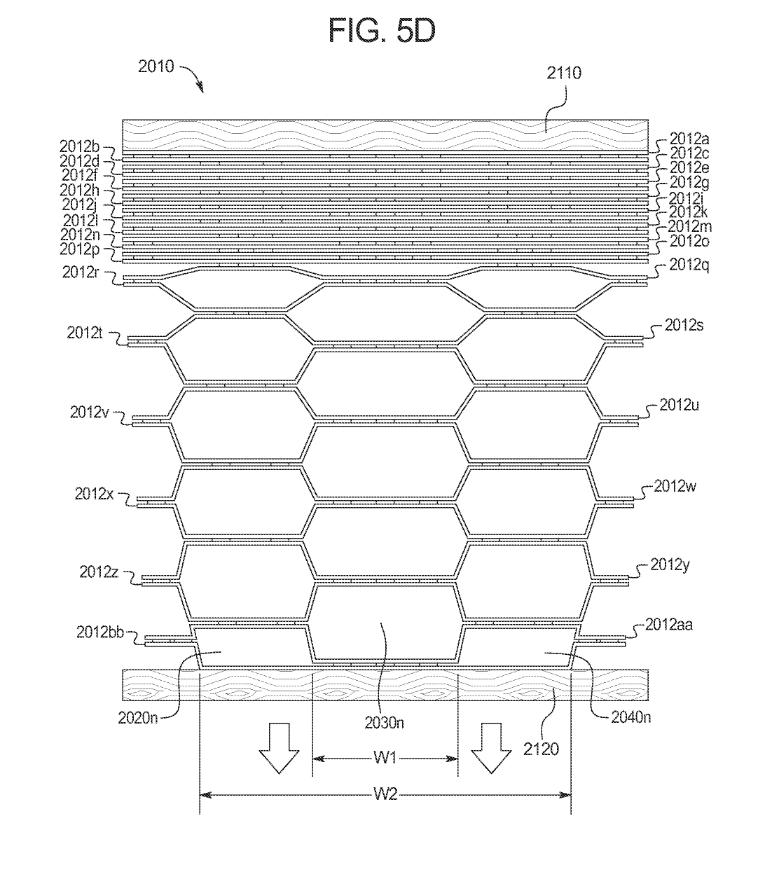

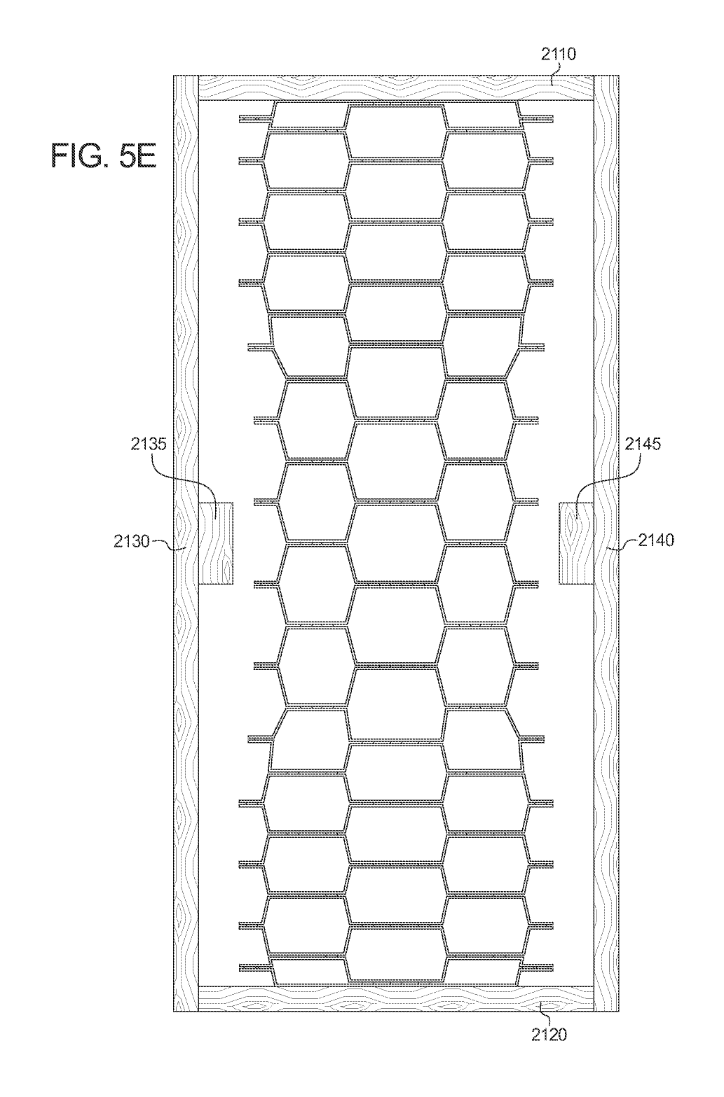

FIGS. 5A to 5E illustrate another embodiment of the void filler of the present disclosure, which is generally indicated by numeral 2010. In this embodiment, the void filler 2010 includes a plurality of rectangular plies 2012a to 2012bb of corrugated paperboard arranged atop one another to form a stack. Adjacent plies 2012 of the stack are adhered to one another according to the predetermined adherence pattern illustrated in FIG. 5B. In FIG. 5B, each circle represents a center of a line of adherence along which adjacent plies 2012 are adhered to one another. It should be appreciated that the adherence pattern employed to adhere adjacent plies to one another dictates: (a) how the cells of the void filler (described below) are formed when the void filler is expanded from the collapsed state into the expanded state, (b) the size of the cells, and (c) the shape of cells.

When the void filler 2010 is manipulated from the collapsed state to the expanded state, the plies 2012 of the void filler 2010 bend along a plurality of bend lines proximate certain of the lines of adherence to create an open cell structure including: a left group of cells, a middle group of cells; and a right group of cells. In this embodiment, the cells of the left group are generally the same size as the corresponding cells of the right group (as generally described above), and the cells of the middle group are differently sized than the cells of the left group and the cells of the right group (as generally described above). More specifically, in this embodiment, the cells of the middle group are wider than the corresponding cells of the left group and the cells of the right group (as generally described above).

In this embodiment, the size of the cells in each respective group varies. More specifically, for each group of cells, the adherence pattern employed for this embodiment of the void filler 2010 causes the cells to: (a) increase in height (via an increase in length of the upper right side, lower right side, lower left side, and upper left side walls) and decrease in width (via a decrease in length of the top and bottom walls) proceeding from the top of the void filler 2010 downward toward a center of the void filler 2010, (b) reach a maximum height (i.e., a maximum length of the upper right side, lower right side, lower left side, and upper left side walls) and a minimum width (i.e., a minimum length of the top and bottom walls) near the vertical center of the void filler 2010, and (c) decrease in height (via a decrease in length of the upper right side, lower right side, lower left side, and upper left side walls) and increase in width (via an increase in length of the top and bottom walls) proceeding from the center of the void filler 2010 downward toward the bottom of the void filler 2010. This causes the void filler 2010 to have an hourglass shape in the expanded state; that is, in this embodiment, the void filler 2010 is wider at its top and bottom than it is at its center when in the expanded state.

FIGS. 5C to 5E illustrate the void filler 2010 employed as a core of a hollow door. To form the door, as shown in FIG. 5C, a top rail 2110 is connected to the top ply 2012a of the void filler 2010 (when in the collapsed state) and a bottom rail 2120 is connected to the bottom ply 2012bb of the void filler 2010. More specifically, in this example embodiment, the bottom surface of the top rail 2110 is adhered to a designated attachment portion of the top surface of the top ply 2012a of the void filler 2010 via an adhesive (such as glue), and the top surface of the bottom rail 2120 is adhered to a designated attachment portion of the bottom surface of the bottom ply 2012bb of the void filler 2010 via an adhesive (such as glue). It should be appreciated that the top and bottom plies of the void filter may be connected to the top and bottom rails, respectively, in any suitable manner.

As best shown in FIG. 5D, the width W2 of the designated attachment portion of the bottom surface of the bottom ply 2012bb attached to the top surface of the bottom rail 2120 is greater than the width W1 of the bottom wall of the bottommost cell 2030n of the middle group of cells of the void filter 2010 (with respect to the orientation shown in FIG. 5D). Similarly, as best shown in FIG. 5E, the width of the designated attachment portion of the top surface of the top ply 2012a attached to the bottom surface of the top rail 2110 is greater than the width of the top wall of the topmost cell of the middle group of cells of the void filler 2010 (with respect to the orientation shown in FIG. 5E). These relatively wide designated attachment portions (as compared to the widths of the corresponding designated attachment portions described above with respect to the embodiments illustrated in FIGS. 1A to 4D) are beneficial in that they facilitate even, symmetric, and complete expansion of the void filler into the expanded state, particularly for void fillers having plies with relatively narrow widths.

As illustrated in FIG. 5D, the void filler 2010 is expanded from the collapsed state to the expanded state by: (a) holding the top rail 2110 stationary and pulling the bottom rail 2120 downward, (b) holding the bottom rail 2120 stationary and pulling the top rail 2110 upward, or (c) a combination of (a) and (b). It should be appreciated that the void filler 2010 expands evenly and symmetrically when being manipulated from the collapsed state to the expanded state and does not interfere with the lock block location(s) (explained below).

As shown in FIG. 5E, after the void filler 2010 is in the expanded state, a left stile 2130 is connected to the left ends of the top rail 2110 and the bottom rail 2120 and a right stile 2140 is connected to the rights ends of the top rail 2110 and the bottom rail 2120 to form a frame of the door 2100. A left lock block or mounting block 2135 and a right lock block or mounting block 2145, which provide mounting bases for a door handle and locking assembly (not shown), are attached to the left stile 2130 and the right stile 2140, respectively. Front and back door skins (not shown) are attached to the front and back, respectively, of the door frame and the void filler 2010 to complete assembly of the door.

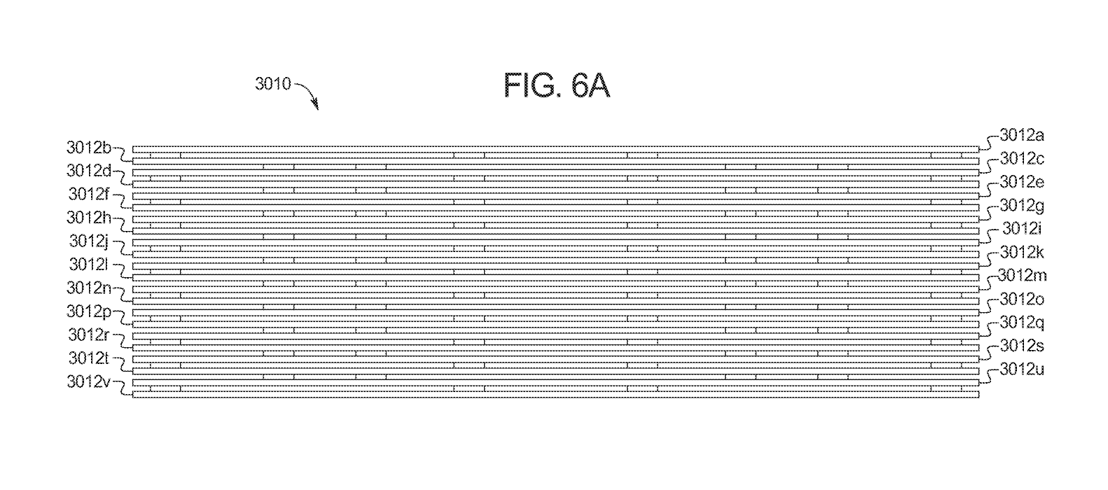

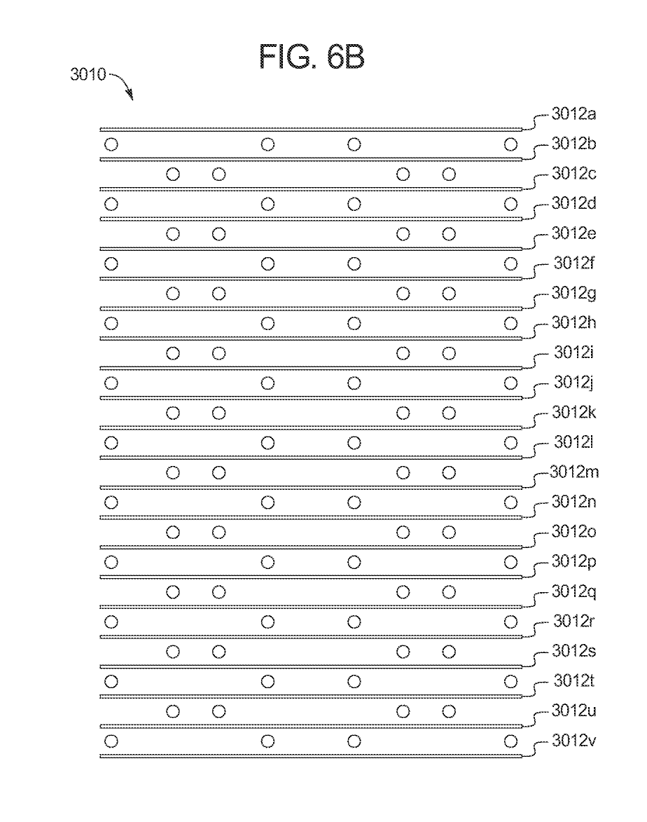

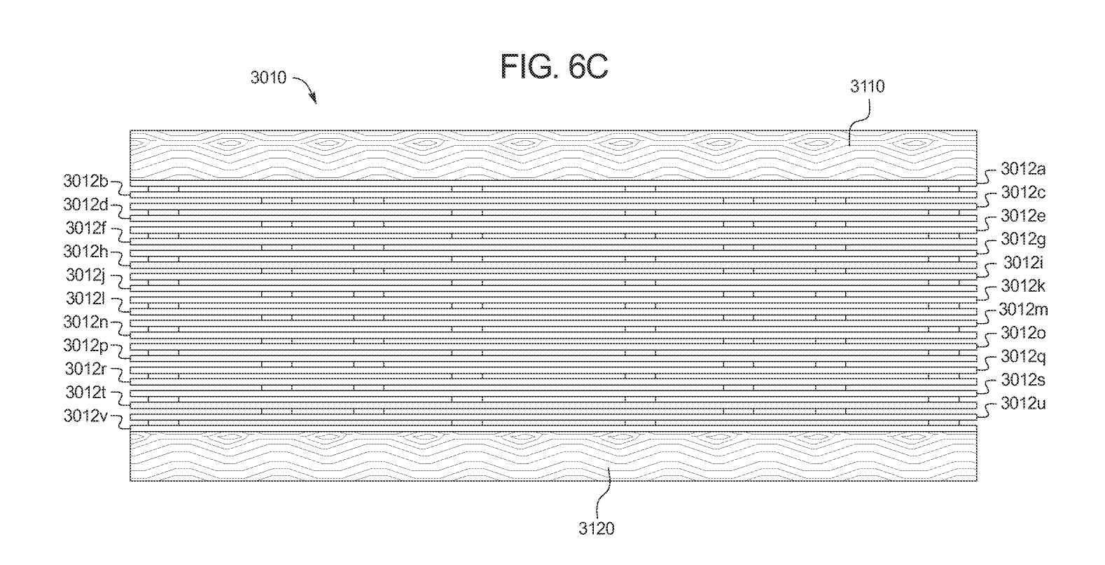

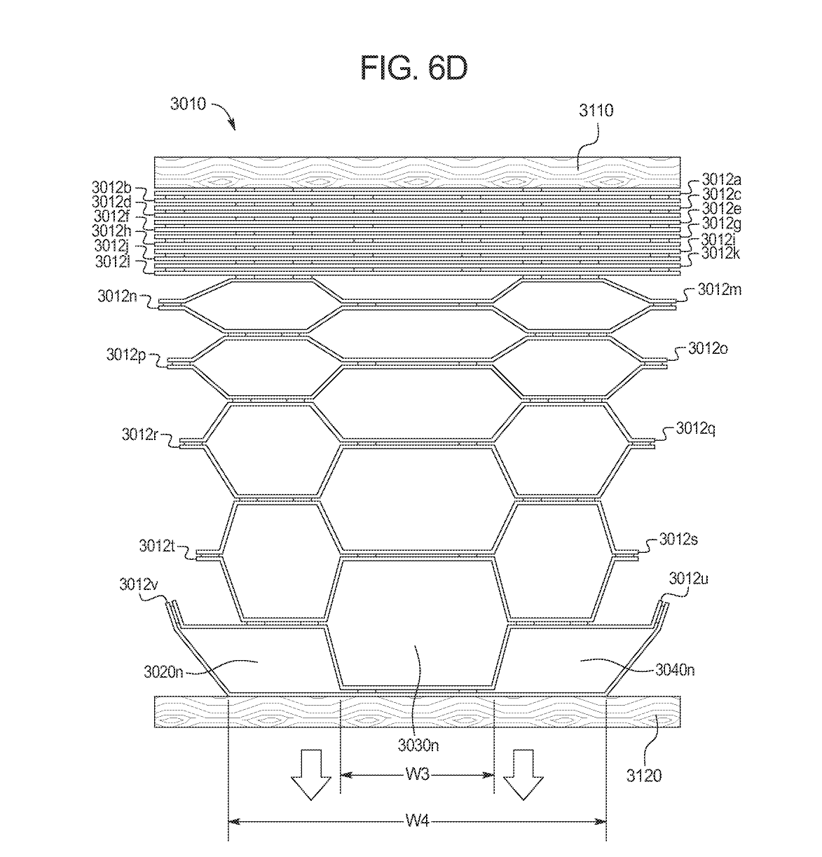

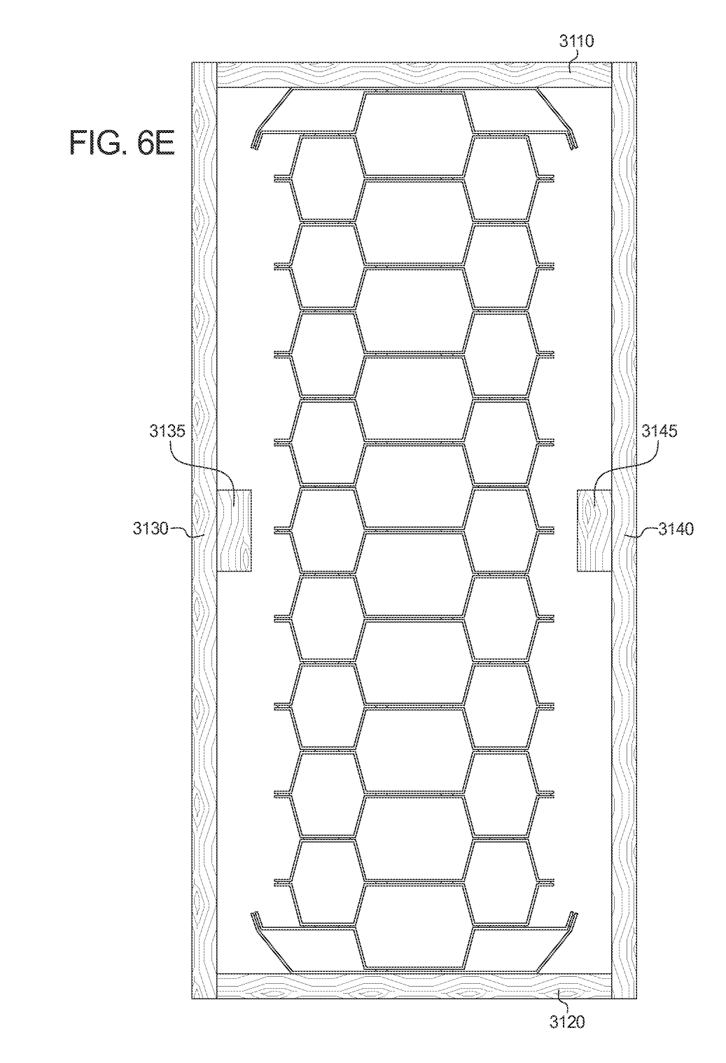

FIGS. 6A to 6E illustrate another embodiment of the void filler of the present disclosure, which is generally indicated by numeral 3010. In this embodiment, the void filler 3010 includes a plurality of rectangular plies 3012a to 3012v of corrugated paperboard arranged atop one another to form a stack. Adjacent plies 3012 of the stack are adhered to one another according to the predetermined adherence pattern illustrated in FIG. 6B. In FIG. 6B, each circle represents a center of a line of adherence along which adjacent plies 3012 are adhered to one another. It should be appreciated that the adherence pattern employed to adhere adjacent plies to one another dictates: (a) how the cells of the void filler (described below) are formed when the void filler is expanded from the collapsed state into the expanded state, (b) the size of the cells, and (c) the shape of cells.

When the void filler 3010 is manipulated from the collapsed state to the expanded state, the plies 3012 of the void filler 3010 bend along a plurality of bend lines proximate certain of the lines of adherence to create an open cell structure including: a left group of cells; a middle group of cells; and a right group of cells. In certain embodiments, the plies are scored, perforated, or creased along at least part of one or more of the bend lines to facilitate bending of the plies when the void filler is manipulated from the collapsed state to the expanded state.

FIGS. 6C to 6E illustrate the void filler 3010 employed as a core of a hollow door. To form the door, as shown in FIG. 6C, a top rail 3110 is connected to the top ply 3012a of the void filler 3010 (when in the collapsed state) and a bottom rail 3120 is connected to the bottom ply 3012v of the void filler 3010. More specifically, in this example embodiment, the bottom surface of the top rail 3110 is adhered to a designated attachment portion of the top surface of the top ply 3012a of the void filler 3010 via an adhesive (such as glue), and the top surface of the bottom rail 3120 is adhered to a designated attachment portion of the bottom surface of the bottom ply 3012v of the void filler 3010 via an adhesive (such as glue). It should be appreciated that the top and bottom plies of the void filter may be connected to the top and bottom rails, respectively, in any suitable manner.

As best shown in FIG. 6D, the width W4 of the designated attachment portion of the bottom surface of the bottom ply 3012v attached to the top surface of the bottom rail 3120 is greater than the width W3 of the bottom wall of the bottommost cell 3030n of the middle group of cells of the void filler 3010 (with respect to the orientation shown in FIG. 6D). Similarly, as best shown in FIG. 6E, the width of the designated attachment portion of the top surface of the top ply 3012a attached to the bottom surface of the top rail 3110 is greater than the width of the top wall of the topmost cell of the middle group of cells of the void filler 3010 (with respect to the orientation shown in FIG. 6E). These relatively wide designated attachment portions (as compared to the widths of the corresponding designated attachment portions described above with respect to the embodiments illustrated in FIGS. 1A to 4D) are beneficial in that they facilitate even, symmetric, and complete expansion of the void filler into the expanded state, particularly for void fillers having plies with relatively narrow width.

As illustrated in FIG. 6D, the void filler 3010 is expanded from the collapsed state to the expanded state by: (a) holding the top rail 3110 stationary and pulling the bottom rail 3120 downward, (b) holding the bottom rail 3120 stationary and pulling the top rail 3110 upward, or (c) a combination of (a) and (b). It should be appreciated that the void filler 3010 expands evenly and symmetrically when being manipulated from the collapsed state to the expanded state and does not interfere with the lock block location(s) (explained below).

As shown in FIG. 6E, after the void filler 3010 is in the expanded state, a left stile 3130 is connected to the left ends of the top rail 3110 and the bottom rail 3120 and a right stile 3140 is connected to the rights ends of the top rail 3110 and the bottom rail 3120 to form a frame of the door 3100. A left lock block or mounting block 3135 and aright lock block or mounting block 3145, which provide mounting bases for a door handle and locking assembly (not shown), are attached to the left stile 3130 and the right stile 3140, respectively. Front and back door skins (not shown) are attached to the front and back, respectively, of the door frame and the void filler 3010 to complete assembly of the door.

In certain embodiments, the length of the plies of the void filler is substantially the same as the length of the top and bottom rails of the door in which the void filler will be employed such that the length of the void filler in the collapsed state is substantially the same as the length of the top and bottom rails of the door in which the void filler will be employed. For instance, a door having 24 inch long top and bottom rails will employ a void filler having 24 inch long plies, a door having a 26 inch long top and bottom rails will employ a void filler having 26 inch long plies, and so on. This facilitates attachment of the void filler to the top and bottom rails, as the void filler does not have to be manually centered on the top and bottom rails.

In other embodiments, embodiments, the plies of the void filler are slightly longer than the length of the top and bottom rails.

In other embodiments, a void filler is sized such that it may be employed with one of a plurality of different sized doors. In these embodiments, the length of the plies of the void filler is smaller than the length of the top and bottom rails of the narrowest door with which the void filler may be employed.

While the void filler is described above as being employed within hollow doors, it should be appreciated that the void filler may be used for other suitable applications, such as dunnage applications.

It should be appreciated that the void filler of the present disclosure may be employed in an automated door lay up (or door construction) process, a hand or manual door lay up process, or a door lay up process that is partly automated and partly manual. It should be appreciated that, in certain manual door lay up processes, the void filler is not attached to the top rail, the bottom rail, or both. It should further be appreciated that the void filler of the present disclosure may be employed in any suitable type of door, such as a six-panel door, a four-panel door, or a two-panel door.

It should be understood that modifications and variations may be effected without departing from the scope of the novel concepts of the present disclosure, and it should be understood that this application is to be limited only by the scope of the appended claims.

The invention is claimed as follows:

1. A void filler comprising:
a plurality of plies attached to one another such that, when in an expanded state, the plies form:
(a) a first group of cells;
(b) a second group of cells, the cells of the second group of cells being substantially the same size as the cells of the first group of cells; and
(c) a third group of cells between the first group of cells and the second group of cells, the cells of the third group of cells being wider than the cells of the first group of cells and the cells of the second group of cells.

2. The void filler of claim 1, wherein the cells are generally hexagonal.

3. The void filler of claim 1, wherein the groups are columns.

4. The void filler of claim 1, wherein the cells of the first group of cells, the cells of the second group of cells, and the cells of the third group of cells have substantially the same height.

5. The void filler of claim 1, which includes a first end, a second end, and a center therebetween, and wherein the cells proximate the first end and the cells proximate the second end are wider and shorter than the cells proximate the center.

6. The void filler of claim 5, wherein the first end is a top end and the second end is a bottom end.

7. A void filler comprising:
a plurality of plies attached to one another such that, when in an expanded state, the plies form:
(a) a first group of generally hexagonal cells;
(b) a second group of generally hexagonal cells, the cells of the second group of cells being substantially the same size as the cells of the first group of cells; and
(c) a third group of generally hexagonal cells between the first group of cells and the second group of cells, the cells of the third group of cells being wider than the cells of the first group of cells and the cells of the second group of cells.

8. The void filler of claim 7, wherein the groups are columns.

9. The void filler of claim 7, wherein the cells of the first group of cells, the cells of the second group of cells, and the cells of the third group of cells have substantially the same height.

10. The void filler of claim 7, which includes a first end, a second end, and a center therebetween, and wherein the cells proximate the first end and the cells proximate the second end are wider and shorter than the cells proximate the center.

11. The void filler of claim 10, wherein the first end is a top end and the second end is a bottom end.

12. A void filler comprising:
a plurality of plies attached to one another such that, when in an expanded state, the plies form:
(a) a first group of cells;
(b) a second group of cells, the cells of the second group of cells being substantially the same size as the cells of the first group of cells; and
(c) a third group of cells between the first group of cells and the second group of cells, the cells of the third group of cells being wider than the cells of the first group of cells and the cells of the second group of cells,
wherein the cells proximate a first end of the void filler and the cells proximate a second end of the void filler are wider and shorter than the cells proximate a center of the void filler between the first end and the second end.

13. The void filler of claim 12, wherein the cells are generally hexagonal.

14. The void filler of claim 12, wherein the groups are columns.

15. The void filler of claim 12, wherein the cells of the first group of cells, the cells of the second group of cells, and the cells of the third group of cells have substantially the same height.

16. The void filler of claim 12, wherein the first end is a top end and the second end is a bottom end.

17. A door comprising:
(a) a door frame including a first rail and an opposing second rail; and
(b) avoid filler attached to the door frame and including a plurality of plies, wherein:
(i) a first ply is connected to the first rail;
(ii) a second ply is connected to the second rail; and
(iii) the plies are attached to one another such that the plies form:
(A) a first group of cells;
(B) a second group of cells, the cells of the second group of cells being substantially the same size as the cells of the first group of cells; and
(C) a third group of cells between the first group of cells and the second group of cells, the cells of the third group of cells being wider than the cells of the first group of cells and the cells of the second group of cells.

18. The door of claim 17, wherein the groups are columns.

19. The door of claim 17, wherein the door frame includes a first stile connecting a first end of the first rail to a first end of the second rail and a second opposing stile connecting a second end of the first rail to a second end of the second rail.

20. The door of claim 17, wherein the door frame includes at least one lock block connected to one of the stiles.

21. The door of claim 17, which includes a first door skin attached to a first side of the door frame and a second door skin attached to an opposing second side of the door frame.

22. The door of claim 17, wherein the cells are generally hexagonal.

23. The door of claim 17, wherein the cells of the first group of cells, the cells of the second group of cells, and the cells of the third group of cells have substantially the same height.

24. The door of claim 17, wherein the void filler includes a top end, a bottom end, and a center therebetween, and wherein the cells proximate the top end and the cells proximate the bottom end are wider and shorter than the cells proximate the center.

25. A door comprising:
(a) a door frame including:
(i) a first rail,
(ii) an opposing second rail,
(iii) a first stile connecting a first end of the first rail to a first end of the second rail,
(iv) a second opposing stile connecting a second end of the first rail to a second end of the second rail, and
(v) at least one lock block connected to one of the stiles;
(b) a void filler including a plurality of plies, wherein:
(i) a first ply is connected to the first rail;
(ii) a second ply is connected to the second rail; and
(iii) the plies are attached to one another such that the plies form:
(A) a first column of generally hexagonal cells;
(B) a second column of generally hexagonal cells, the cells of the second column of cells being substantially the same size as the cells of the first column of cells; and
(C) a third column of generally hexagonal cells between the first column of cells and the second column of cells, the cells of the third column of cells being wider than the cells of the first column of cells and the cells of the second column of cells;
(c) a first door skin attached to a first side of the door frame; and
(d) a second door skin attached to an opposing second side of the door frame.

26. The door of claim 25, wherein the cells of the first column of cells, the cells of the second column of cells, and the cells of the third column of cells have substantially the same height.

27. The door of claim 25, wherein the void filler includes a top end, a bottom end, and a center therebetween, and wherein the cells proximate the top end and the cells proximate the bottom end are wider and shorter than the cells proximate the center.
